(19) United States
(12) Patent Application Publication
(10) Pub. No.: US 2026/0117964 A1
(43) Pub. Date: Apr. 30, 2026

(54) LIGHTWEIGHT WINTERIZED LAMP

(71) Applicant: Formosawide Industries Inc., Silang (PH)

(72) Inventor: Kuo-Liang TANG, Miaoli County (TW)

(73) Assignee: Formosawide Industries Inc., Silang (PH)

(21) Appl. No.: 19/368,211

(22) Filed: Oct. 24, 2025

Related U.S. Application Data
(60) Provisional application No. 63/711,708, filed on Oct. 25, 2024.

(51) Int. Cl. F21V 31/03; F21K 9/64; F21V 9/45; F21V 21/002; F21V 25/12; F21V 29/85; F21V 31/00; F21Y 115/10

(52) U.S. Cl. CPC F21V 31/03; F21K 9/64; F21V 9/45; F21V 21/002; F21V 25/12; F21V 29/85; F21V 31/005; F21Y 2115/10

(57) ABSTRACT

A lightweight winterized lamp, including: a snap-on bottom cover; a lamp main body base, including a first side to receive a light bulb, and a second side to engage the snap-on bottom cover, to define a closed internal space within the lightweight winterized lamp, wherein a portion of an external conductive wire is restrained inside the closed internal space by an engagement between the snap-on bottom cover and the lamp main body base; and a winter-resilient mechanism, disposed in the closed internal space or the light bulb, or on at least one of the snap-on bottom cover and the lamp main body base, to mitigate luminous degradation possibility of the lightweight winterized lamp attributable to freezing temperatures and/or icing on the lightweight winterized lamp.

### BACKGROUND OF THE INVENTION

### Field of Invention

The present invention relates to outdoor lighting devices. More particularly, it relates to lightweight winterized lamps and decorative lighting assemblies configured for cold-climate operation.

### Description of Related Art

Under severe weather statuses of snow, freezing rain, and freeze-thaw cycling, outdoor decorative lamps and lamp bases used in cold climates must be able to maintain enclosure integrity, sustain luminous performance, and purge interior moisture into outside. Conventional approaches substantially rely on ingress-protection (IP) ratings, which are suitable for wet weather, not for operations under severe weather. Further, sealed housings tend to “breathe” under temperature changes in cold climates, drawing interior moisture to a lower condensation status becomes significant.

Cold weather may interact with optical performance. For example, white LEDs can exhibit luminous-flux loss and color drift through years due to aging of encapsulants, humidity resistance degradation, or package delamination-phenomena that may be accelerated by environmental moisture and temperature cycling.

### SUMMARY OF THE INVENTION

In view of the aforementioned technical needs, the present invention provides a lightweight winterized lamp, including: a snap-on bottom cover; a lamp main body base, including a first side to receive a light bulb, and a second side to engage the snap-on bottom cover, to define a closed internal space within the lightweight winterized lamp, wherein a portion of an external conductive wire is restrained inside the closed internal space by an engagement between the snap-on bottom cover and the lamp main body base; and a winter-resilient mechanism, disposed in the closed internal space or the light bulb, or on at least one of the snap-on bottom cover and the lamp main body base, to reduce adverse effects on luminous output of the lightweight winterized lamp attributable to freezing temperatures and/or icing on the lightweight winterized lamp.

In one embodiment, the winter-resilient mechanism purges moisture or drains water from the closed internal space to the outside of the lightweight winterized lamp, de-ices the outer surface of the lightweight winterized lamp, or compensates for the luminous output decrease of the lightweight winterized lamp by regulating luminous color drift.

In one embodiment, the winter-resilient mechanism includes a moisture-permeable protective vent, which vents/purges the moisture from the closed internal space and prevents outside liquid water from entering the closed internal space.

In one embodiment, the moisture-permeable protective vent may be shielded with a splash shield and/or a labyrinth hood on the outer surface of the lightweight winterized lamp.

In one embodiment, the moisture-permeable protective vent includes: a microporous membrane formed of expanded polytetrafluoroethylene (ePTFE) with an oleophobic surface treatment; and a membrane sealing element, formed of a weather-resistant elastomer to bond the microporous membrane to the snap-on bottom cover or the lamp main body base.

In one embodiment, the winter-resilient mechanism includes at least one movable phosphor-conversion element. When a sensed luminous output of the light bulb falls below a threshold, the movable phosphor-conversion element is translated from a retracted position into a deployed position in the light bulb, to at least partially surround an LED light source in the light bulb. In another perspective of the winter-resilient mechanism, the movable phosphor-conversion element is displaced to vary a source-to-phosphor gap between the LED light source and the movable phosphor-conversion element, to compensate for the luminous output decrease or color drift of the LED light source.

In one embodiment, the movable phosphor-conversion element may be formed as a rigid plate selected from a phosphor-in-glass (PiG) plate or a ceramic phosphor plate, optionally with an ultraviolet-stabilized protective coating and a diffusive micro-texture to improve luminous color uniformity under cold-climate operation.

In one embodiment, the LED light source is disposed in a G40 light bulb.

In one embodiment, an icing-prone region around the moisture-permeable protective vent on the outer surface, may be covered with an ice-phobic coating to reduce a static ice-adhesion strength on the outer surface of the lightweight winterized lamp; or, the lightweight winterized lamp further includes a resonator to induce mechanical vibration over the icing-prone region, to shed accreted ice from the outer surface.

In one embodiment, the icing-prone region includes a drainage pathway, an outlet edge, a vent shield, a grille member, a splash shield, or a labyrinth hood.

In one embodiment, the material of the ice-phobic coating includes an ultraviolet stabilizing agent.

In one embodiment, a PCB is disposed in the closed internal space, to electrically connect the external conductive wire by piercing an insulation of the external conductive wire when the snap-on bottom cover is engaging with the lamp main body base.

In one embodiment, the snap-on bottom cover is secured to the lamp main body base by a quick-release locking mechanism.

In one embodiment, the light bulb is substantially made of an explosion-resistant transparent material.

The objectives, technical details, features, and benefits of the present invention can be better understood with regard to the detailed description of the embodiments below, with reference to the associated drawings.

### BRIEF DESCRIPTION OF THE DRAWINGS

FIGS. 1A, 1B, and 1C, show several schematic diagrams of the lightweight winterized lamp according to one embodiment of the present invention.

FIGS. 2A and 2B show schematic diagrams of dispositions of the peripheral elastomeric gaskets according to two embodiments of the present invention, respectively.

FIGS. 3A and 3B show schematic drawings of the operations of the moisture-permeable protective vent according to one embodiment of the present invention.

FIGS. 4A and 4B, respectively show a splash shield and a labyrinth hood in front of the moisture-permeable protective vent according to two embodiments of the present invention.

FIGS. 5A and 5B, respectively, show two positions of the movable phosphor-conversion elements according to one embodiment of the present invention.

FIG. 6 shows schematic drawings of quick-release locking mechanism according to one embodiment of the present invention.

### DESCRIPTION

The objectives, technical details, features, and effects of the present invention can be better understood with regard to the detailed description of the embodiments below, with reference to the associated drawings. The technical wordings/terms in this specification are based on a customary understanding of the art. In this specification, the interpretations of these wordings/terms are preferentially based on the description or the definition in this specification. Each embodiment of the present invention includes at least one technical feature. To the extent possible, a person having ordinary knowledge in the art may, as needed, select, combine, or modify some or all of the technical features in any one of the embodiments, within the spirit and scope of the present invention.

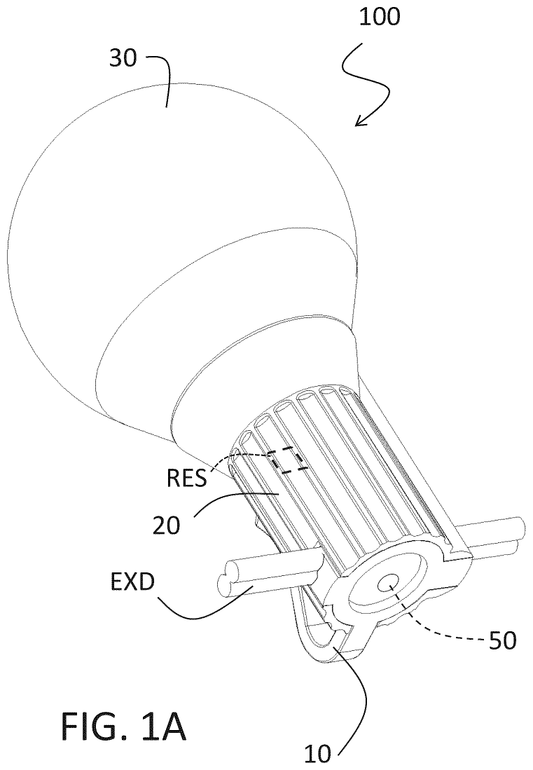

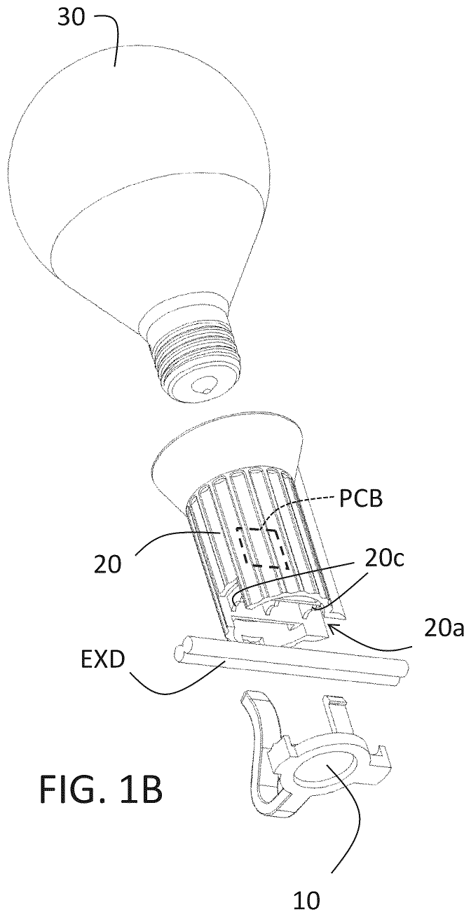

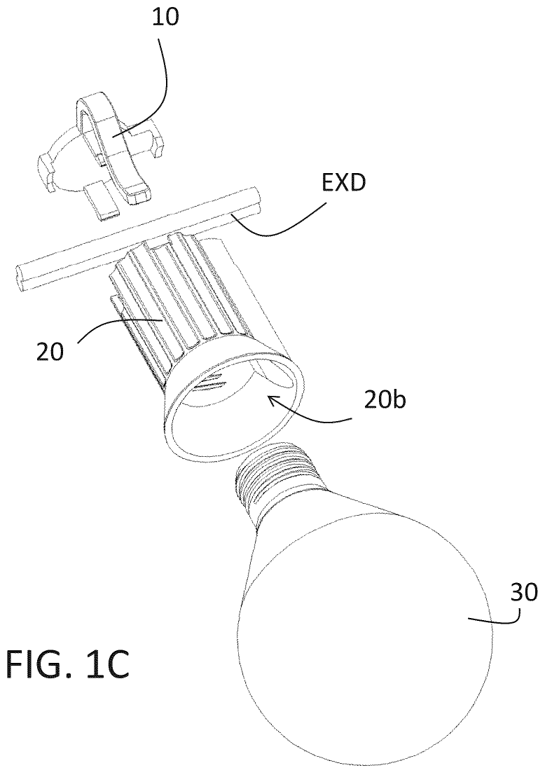

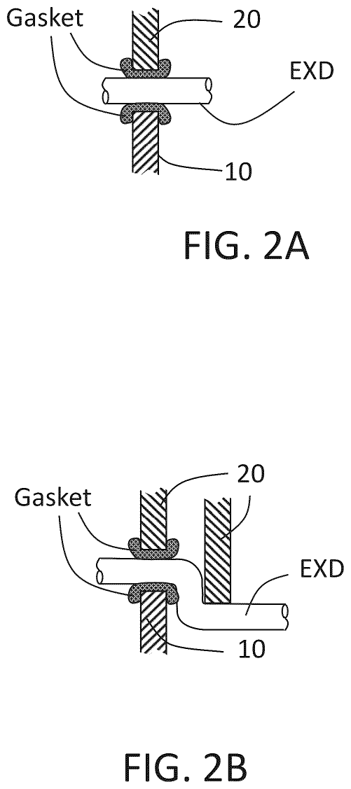

Please refer to FIG. 1A, wherein the present invention provides a lightweight winterized lamp 100, including: a snap-on bottom cover 10; a lamp main body base 20, including a first side 20a (FIG. 1B) to receive a light bulb 30, and a second side 20b (FIG. 1C) to engage the snap-on bottom cover 10, to define a closed internal space within the lightweight winterized lamp 100, wherein a portion of an external conductive wire EXD is restrained inside the closed internal space by an engagement between the snap-on bottom cover 10 and the lamp main body base 20; and a winter-resilient mechanism 50, disposed in the closed internal space or the light bulb 30, or on at least one of the snap-on bottom cover 10 or the lamp main body base 20 (the disposition of the winter-resilient mechanism 50 on the snap-on bottom cover 10, is one example of the disposition of the winter-resilient mechanism 50), to reduce adverse effects on luminous output of the lightweight winterized lamp 100 attributable to winter sunlight, freezing temperatures and/or icing on the lightweight winterized lamp 100. As shown in FIG. 1A, in one embodiment, the portion of the external conductive wire EXD within the closed space, can be restrained and sealed in combination with a peripheral elastomeric gasket (FIG. 2A or 2B) and/or a wire-retention groove 20c (FIG. 1B) as strain relief to isolate outside water, moisture and dust from entering the closed internal space.

In one embodiment, the winter-resilient mechanism 50 can purge moisture or drain water from the closed internal space to the outside of the lightweight winterized lamp 100, de-ice the outer surface of the lightweight winterized lamp 100, or compensate for the luminous output decrease of the light bulb 30 by regulating luminous color drift. The details are explained as follows:

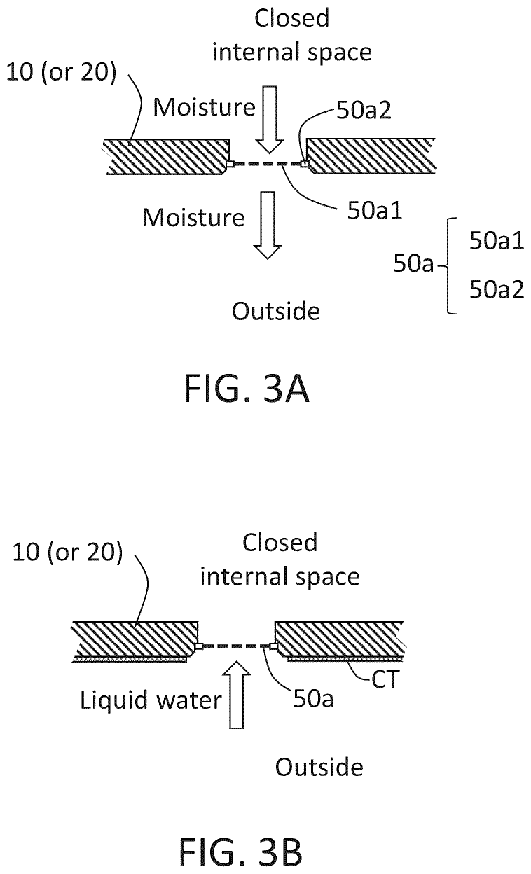

In one embodiment, the winter-resilient mechanism 50 includes a moisture-permeable protective vent 50a (disposed on the snap-on bottom cover 10 or the lamp main body base 20, see FIG. 3A), which vents/purges the moisture from the closed internal space and prevents outside liquid water from entering into the closed internal space (FIG. 3B). Functionally, the moisture-permeable protective vent 50a provides three protection functions in cold and wet environments:
(1) Liquid and contaminant exclusion: the hydrophobic/oleophobic function of the moisture-permeable protective vent 50a, blocking liquid water under outside spray and splash, and intercepting salt crystals and other particulates, to reduce deposition of conductive salts and mitigate salt corrosion on internal circuitry.
(2) Rapid pressure equalization: by passing gases through low-pressure differences across the moisture-permeable protective vent 50a, the moisture-permeable protective vent 50a equalizes internal/external pressure differences, which reduces suction-pumping through micro-leaks that could otherwise draw in moisture.
(3) Condensation control: by continuously releasing moisture vapor to the outside, the moisture-permeable protective vent 50a lowers internal humidity and thereby suppresses condensation on optics and electronics of the lightweight winterized lamp 100, to extend component life and stabilize photometric performance.

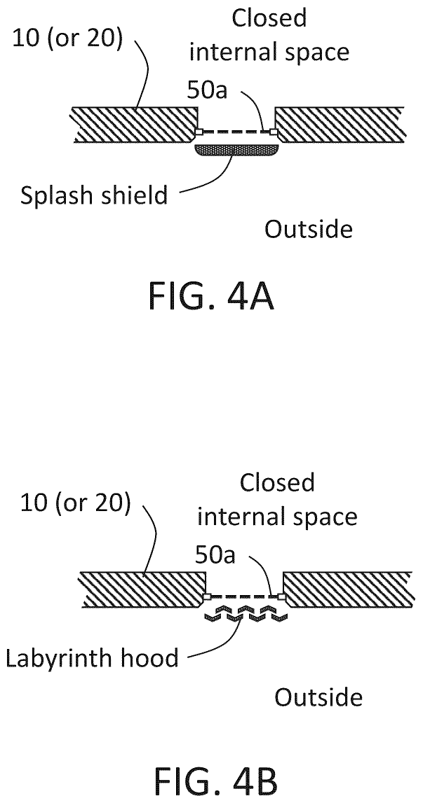

In one embodiment, the moisture-permeable protective vent 50a may be shielded with a splash shield (FIG. 4A) and/or a labyrinth hood (FIG. 4B) on the outer surface of the lightweight winterized lamp 100. For robust winter operation, the moisture-permeable protective vent 50a may be positioned in a recessed, splash-shielded region and/or covered by the splash shield and/or the labyrinth hood, to prevent water or ice from blanketing the moisture-permeable protective vent 50a. As shown in the figures, the outward directions of the splash shield or the labyrinth hood are preferred to be downward for preventing water or ice from entering the moisture-permeable protective vent 50a upwardly.

In one embodiment, the moisture-permeable protective vent 50a includes: a microporous membrane 50a1 (FIG. 3A) formed of expanded polytetrafluoroethylene (ePTFE) with an oleophobic surface treatment, to include gas-transmissive and liquid-water-impermeable capabilities; and a membrane sealing element 50a2 (FIG. 3A), formed of a weather-resistant elastomer to bond the microporous membrane 50a1 to the snap-on bottom cover 10 or the lamp main body base 20, such that an active membrane region of the microporous membrane 50a1 remains exposed and free.

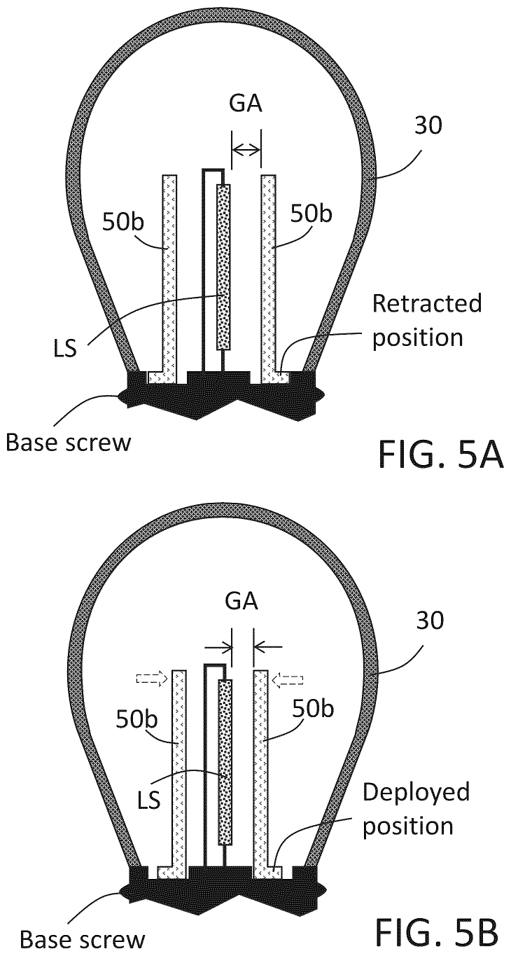

As shown in FIG. 5A, in one embodiment, the winter-resilient mechanism 50 includes at least one movable phosphor-conversion element 50b. When a sensed luminous output of the light bulb 30 falls below a threshold, the movable phosphor-conversion element 50b may be translated from a retracted position into a deployed position in the light bulb 30 (FIG. 5B), to at least partially surround an LED light source LS in the light bulb 30. In another perspective of the winter-resilient mechanism 50, the movable phosphor-conversion element 50b is displaced to vary a source-to-phosphor gap GA between the LED light source LS and the movable phosphor-conversion element 50b (GA in FIG. 5B is shorter than GA in FIG. 5A), compensating for the luminous output decrease or color drift of the LED light source LS. A movement of the movable phosphor-conversion element 50b may be actuated in response to a sensed luminous output or color metric, for tuning the luminous output or the color drift of the light bulb 30, to regulate the visible light from the light bulb 30 to the users' naked eye. When a built-in photometric sensor (e.g., photodiode, ambient light sensor, CCT sensor, or RGB sensor) detects that luminous output falls below the threshold or the color drift exceeds an allowable range, a controller commands either of two actions:
(1) Element translation: the movable phosphor-conversion elements 50b are translated from a retracted positions to the deployed positions within the bulb interior, to increase the movable phosphor-conversion elements' intercepted solid angle, to rebalance the spectrum, luminous flux, and color rendering to achieve the original luminous status.
(2) Gap adjustment: the movable phosphor-conversion element 50b is displaced to vary the source-to-phosphor gap GA between the LED light source LS and the movable phosphor-conversion element 50b, typically within a calibratable range (e.g., 0.5-4 mm). The controller may use a lookup table to decide the displacement to meet a target luminous status without adjusting the electrical power of the LED light source LS.
   Wherein, changing the source-to-phosphor spacing alters the phosphor's intercepted solid angle and irradiance, which in turn changes the conversion fraction and phosphor temperature. A smaller gap increases conversion, boosts yellow/red content, warms the spectrum, recovers luminous flux, and typically improves color rendering. A larger gap reduces conversion, raises the blue component, and may shift luminous efficacy. Thus, by tuning the gap (or, changing the positions of the movable phosphor-conversion elements 50b), the lamp simultaneously controls spectrum and luminous flux, without changing electrical consumption.

In one embodiment, the movable phosphor-conversion element 50b may be formed as a rigid plate selected from a phosphor-in-glass (PiG) plate or a ceramic phosphor plate, optionally with an ultraviolet-stabilized protective coating and a diffusive micro-texture to improve luminous color uniformity under cold-climate operation. The movable phosphor-conversion element 50b may be implemented as a rigid plate, to provide high thermal stability, and resistance to moisture for cold-climate service. A diffusive micro-texture on at least one surface of the movable phosphor-conversion element 50b may promote angular mixing, reduce hot spots, and improve luminous color uniformity when the rigid plate is moved between retracted and deployed positions.

As shown in FIGS. 5A and 5B, in one embodiment, the LED light source LS is disposed in a G40 light bulb 30. When needed, the light bulb 30 can include other bulb diameters and corresponding bulb base screw sizes. That is, other suitable bulb diameters and corresponding base screw sizes for Christmas outdoor decorative lights.

In one embodiment, an icing-prone region around the moisture-permeable protective vent 50a on the outer surface, may be covered with an ice-phobic coating CT (FIG. 3B) to reduce a static ice-adhesion strength on the outer surface of the lightweight winterized lamp 100. The icing-prone region surrounding the moisture-permeable protective vent 50a is covered with the ice-phobic coating CT, to reduce static ice-adhesion strength on the outer surface. For example, the suitable coatings for the ice-phobic coating CT, include: low-surface-energy fluoropolymer finishes, or lubricant-infused porous surfaces. The coating can be selectively applied to vent shields, and drip-edge features while leaving the active membrane region of the microporous membrane 50a1 uncoated, thereby preserving moisture vapor transmissivity and water-entry resistance. The reduced adhesion promotes passive ice release under cold weather or resonator RES vibration, to prevent water/ice from blanketing the moisture-permeable protective vent 50a. Or, the lightweight winterized lamp 100 further includes a resonator RES (FIG. 1A) to induce mechanical vibration over the icing-prone region, to shed accreted ice from the outer surface. The resonator RES can be piezoelectric, electromagnetic, or eccentric-mass type to be driven at or near a structural resonant mode. Actuation can be triggered by temperature sensing, pressure difference, or optical/impedance ice detection.

In one embodiment, the icing-prone region includes a drainage pathway, an outlet edge, a vent shield, a grille member, a splash shield, or a labyrinth hood.

In one embodiment, the material of the ice-phobic coating CT includes an ultraviolet stabilizing agent. The winter irradiance can be intense due to snow albedo. Further, the material may include at least one ultraviolet stabilizing agent, to suppress photo-oxidation, yellowing, and embrittlement.

In one embodiment, a printed circuit board (PCB, FIG. 1B) is disposed in the closed internal space, to electrically connect the external conductive wire EXD by piercing (not shown) an insulation of the external conductive wire EXD when the snap-on bottom cover 10 is engaging with the lamp main body base 20. The PCB is disposed within the closed internal space to provide an electrical connection to the external conductive wire EXD during the snap engagement of the snap-on bottom cover 10 with the lamp main body base 20. As the snap-on bottom cover 10 mates with the lamp main body base 20 in an interlocking manner, the wire-retention grooves 20c fit the external conductive wire EXD, and the piercing tines penetrate the insulation to capture the conductor within the external conductive wire EXD, to establish a low-resistance contact without pre-stripping. The external conductive wire EXD is electrically coupled to the PCB through crimped posts, soldered leads, or board-mounted terminals. The snap-on bottom cover 10 and lamp main body base 20 restrain and seal the engaged portion of the external conductive wire EXD, with the elastomeric gasket or grommet to provide ingress protection. In multi-lamp strings, the external conductive wire EXD routes daisy-chain wiring to provide over-current or transient protection. This design enables tool-free field assembly, consistent contact quality, and sealed wire entry compatible with winterized operation.

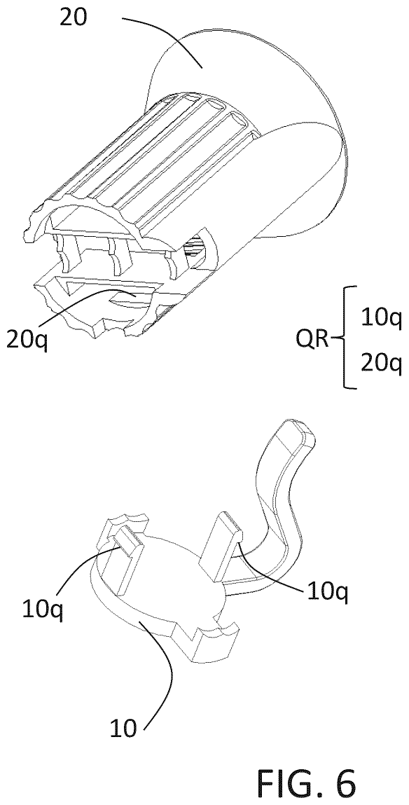

As shown in FIG. 6, in one embodiment, the snap-on bottom cover 10 is secured to the lamp main body base 20 by a quick-release locking mechanism QR (undercuts 20q on the lamp main body base 20 and undercuts 10q the snap-on bottom cover 10) that enables tool-free attachment and removal between the lamp main body base 20 and the snap-on bottom cover 10. In one embodiment, the quick-release locking mechanism QR includes engaging mating catch features on the lamp main body base 20, that may yield an audible “click.” Optional tamper-evident or secondary retainer elements (e.g., a micro screw) may be provided for regulatory compliance.

In one embodiment, the light bulb 30 is substantially made of an explosion-resistant transparent material. The light bulb 30 is substantially formed of an explosion-resistant transparent material for enhancing safety under impact, thermal-shock, or internal over-pressure events. Suitable constructions include tempered glass with controlled compressive surface stress, or a laminated safety glazing (e.g., borosilicate or soda-lime glass bonded with a clear interlayer), and in some variants a glass composite with a hard, UV-resistant coating for scratch and chemical resistance. The envelope thickness and edge finish are selected to resist crack initiation.

The above description discloses distinctive features through several embodiments and/or examples for implementing the features of the present invention. The composition and configurations described above are substantially for illustrating the implementations of the present invention. These descriptions are not intended to limit the scope of the present invention. Further, repeated reference symbols or markings may appear in some embodiments for illustrative clarification purposes. Such repetition does not necessarily imply any necessary connection between the described embodiments or configurations.

The present invention has been disclosed with reference to the above embodiments, which are not intended to limit the spirit and scope of the present invention. A person skilled in the art to which the present disclosure pertains may make various modifications and adjustments without departing from the spirit and scope of the present disclosure. Accordingly, the scope of protection of the present invention can be defined by the claims.

What claim is:

1. A lightweight winterized lamp, including:
a snap-on bottom cover;
a lamp main body base, including a first side to receive a light bulb, and a second side to engage the snap-on bottom cover, to define a closed internal space within the lightweight winterized lamp, wherein a portion of an external conductive wire is restrained inside the closed internal space by an engagement between the snap-on bottom cover and the lamp main body base; and
a winter-resilient mechanism, disposed in the closed internal space or the light bulb, or on at least one of the snap-on bottom cover and the lamp main body base, to reduce adverse effects on luminous output of the lightweight winterized lamp attributable to freezing temperatures and/or icing on the lightweight winterized lamp.

2. The lightweight winterized lamp according to claim 1, wherein the winter-resilient mechanism purges moisture from the closed internal space to the outside of the lightweight winterized lamp, de-ices on the outer surface of the lightweight winterized lamp, or compensates for the luminous output decrease of the light bulb by luminous color drift.

3. The lightweight winterized lamp according to claim 1, wherein the winter-resilient mechanism includes a moisture-permeable protective vent, which vents the moisture from the closed internal space and prevents outside liquid water from entering the closed internal space.

4. The lightweight winterized lamp according to claim 3, wherein the moisture-permeable protective vent is shielded with a splash shield and/or a labyrinth hood on the outer surface of the lightweight winterized lamp.

5. The lightweight winterized lamp according to claim 3, wherein the moisture-permeable protective vent includes: a microporous membrane formed of expanded polytetrafluoroethylene (ePTFE) with an oleophobic surface treatment; and a membrane sealing element 50a2, formed of a weather-resistant elastomer to bond the microporous membrane to the snap-on bottom cover or the lamp main body base.

6. The lightweight winterized lamp according to claim 1, wherein the winter-resilient mechanism includes at least one movable phosphor-conversion element, and wherein, when a sensed luminous output of the light bulb falls below a threshold, the movable phosphor-conversion element is translated from a retracted position to a deployed position to at least partially surround an LED light source in the light bulb; or, the movable phosphor-conversion element is displaced to vary a source-to-phosphor gap between the LED light source and the movable phosphor-conversion element, to compensate the luminous output decrease or color drift of the LED light source.

7. The lightweight winterized lamp according to claim 6, wherein the movable phosphor-conversion element includes a rigid plate selected from a phosphor-in-glass plate or a ceramic phosphor plate, optionally with an ultraviolet-stabilized protective coating and a diffusive micro-texture to improve luminous color uniformity under cold-climate operation.

8. The lightweight winterized lamp according to claim 6, wherein the LED light source is disposed in a G40 light bulb.

9. The lightweight winterized lamp according to claim 1, wherein an icing-prone region on an outer surface of the lightweight winterized lamp around a moisture-permeable protective vent, is covered with an ice-phobic coating to reduce a static ice-adhesion strength on the outer surface of the lightweight winterized lamp; or, the lightweight winterized lamp further includes a resonator to induce mechanical vibration over the icing-prone region, to shed accreted ice from the outer surface.

10. The lightweight winterized lamp according to claim 9, wherein the icing-prone region includes a splash shield, or a labyrinth hood.

11. The lightweight winterized lamp according to claim 9, wherein the ice-phobic coating includes an ultraviolet stabilizing agent.

12. The lightweight winterized lamp according to claim 1, wherein a PCB is disposed in the closed internal space, to electrically connect the external conductive wire by piercing an insulation of the external conductive wire during the engagement between the snap-on bottom cover and the lamp main body base.

13. The lightweight winterized lamp according to claim 1, wherein the snap-on bottom cover is secured to the lamp main body base by a quick-release locking mechanism.

14. The lightweight winterized lamp according to claim 1, wherein the light bulb is substantially made of an explosion-resistant transparent material.
